(19) United States
(12) Patent Application Publication
(10) Pub. No.: US 2010/0251842 A1
(43) Pub. Date: Oct. 7, 2010

(54) GEAR-DRIVEN ASSEMBLY OF TRANSMISSION GEAR SHIFTING

(76) Inventor: Ji-hyun Ma, Gunsan-si (KR)

Correspondence Address: Jae Y. Park, Kile, Goekjian, Reed & McManus, PLLC, 1200 New Hampshire Ave. NW, Suite 570, Washington, DC, 20036, US

(21) Appl. No.: 12/743,538

(22) PCT Filed: Mar. 4, 2008
(86) PCT No.: PCT/KR08/01227

§ 371 Date: May 18, 2010

(30) Foreign Application Priority Data
Nov. 20, 2007 (KR) 10-2007-0118688

(51) Int. Cl. B62M 11/10; F16H 3/08

(52) U.S. Cl. 74/333

(57) ABSTRACT

Disclosed is a gear-driven assembly of transmission gear shifting. The gear-driven assembly comprises: a plurality of driven bevel gears engaging with the driving bevel gears of the gear-driving assembly, respectively; a driven shaft formed with at least one slit in an outer peripheral surface thereof in a longitudinal direction thereof, and having at least one ratchet installation section along an extension line of the slit; a sliding member inserted into the slit to slide to the ratchet installation section in a longitudinal direction of the ratchet installation section; and a plurality of ratchets installed between the ratchet installation section of the driven shaft and a coupling groove of the driven bevel gear such that the ratchets have elastic restoring force, in which the ratchets entirely or partially engage with the coupling groove by performing rotation as the ratchets make contact with the sliding member. Further, each driven bevel gear is coupled with the driven shaft and is formed with the coupling groove in an inner peripheral surface thereof.

### TECHNICAL FIELD

The present invention relates to a gear-driven assembly of transmission gear shifting. More particularly, the present invention relates to a gear-driven assembly of transmission gear shifting, which comprises a gear-driving assembly having a plurality of driving bevel gears concentrically arranged with a different number of teeth, and a gear-driven assembly having a plurality of driven bevel gears installed at a driven shaft such that the driven bevel gears engage with the driving bevel gears.

### BACKGROUND ART

In general, a transport apparatus such as a bicycle moves using driving force transferred through a pedal thereof. The driving force using the pedal is transferred to a rear wheel through a chain. However, in such a bicycle having the above structure, the chain is repeatedly released during a power transfer process, so that power transfer efficiency may deteriorate and thus the chain may be separated from the bicycle.

In order to solve the problems, Korean Unexamined Patent Publication No. 2004-0026785 discloses “driving apparatus for a bicycle” filed by present applicant of the present invention.

In order to minimize power loss in a power transfer process and the number of parts for power transfer by coupling a gear-driven assembly capable of performing gear-shifting with a gear-driving assembly in which driving bevel gears having a different number of teeth are concentrically arranged, Korean Patent Registration No. 2008-0688611 discloses “transmission gear shifting for a bicycle” filed by present applicant of the present invention.

As illustrated in FIG. 1, the transmission gear shifting according to the prior art as described above comprises a gear-driven assembly 22, in which pins 22b moving on a driven shaft 22a are inserted into or separated from grooves formed in a driven bevel gear coupled with the driven shaft 22a, so that gear-shifting can be performed.

However, movement of such pins is caused by hands of a user.

Thus, great force is required for performing gear-shifting such that the driven bevel gear, which rotates together with the driven shaft 22a while engaging with a driving bevel gear positioned at one side of the driven bevel gear, engages with another driving bevel gear positioned at the other side of the driven bevel gear.

Consequently, the gear-shifting may not be easily performed during high speed rotation of the driving bevel gear such as high speed travel.

### DISCLOSURE OF INVENTION

### Technical Problem

The present invention has been made to solve the above problems occurring in the prior art, and an object of the present invention is to provide a gear-driven assembly of transmission gear shifting, in which gear-shifting can be easily performed during high speed rotation of a driving bevel gear by allowing a sliding member to directly rotate a driven bevel gear or by indirectly rotating the driven bevel gear through a ratchet without stopping rotation of the driven bevel gear.

### Technical Solution

In order to accomplish the above object, according to one aspect of the present invention, there is provided a gear-driven assembly of transmission gear shifting comprising: a driven shaft formed with at least one slit in an outer peripheral surface thereof in a longitudinal direction thereof, and having at least one ratchet installation section along an extension line of the slit; a sliding member inserted into the slit to slide to the ratchet installation section in a longitudinal direction of the ratchet installation section; a plurality of driven bevel gears coupled with the driven shaft and formed with a plurality of coupling groove in an inner peripheral surface thereof; and a plurality of ratchets installed between the ratchet installation section of the driven shaft and a coupling groove of the driven bevel gear such that the ratchets have elastic restoring force, in which the ratchets entirely or partially engage with the coupling groove by performing rotation as the ratchets make contact with the sliding member.

According to one embodiment of the present invention, a protrusion is formed at an end of the sliding member, and a lower portion of the sliding member is tapered toward the protrusion.

According to one embodiment of the present invention, if the protrusion of the sliding member is inserted into a lower portion of the ratchet, a first side of the ratchet is locked with the coupling groove of the driven bevel gear and a second side of the ratchet is positioned at the ratchet installation section of the driven shaft, so that the driven bevel gear and the driven shaft, at which the protrusion of the sliding member is located, are driven.

According to another aspect of the present invention, there is provided a gear-driven assembly of transmission gear shifting provided comprising: a driven shaft formed with at least one slit in an outer peripheral surface thereof in a longitudinal direction thereof, and having at least one ratchet installation section along an extension line of the slit; a sliding member inserted into the slit to slide to the ratchet installation section in a longitudinal direction of the ratchet installation section; a plurality of driven bevel gears coupled with the driven shaft and formed with a plurality of coupling groove in an inner peripheral surface thereof; and a plurality of ratchets inserted into a coupling groove of the driven bevel gear such that the ratchets have elastic restoring force, in which the ratchets entirely or partially engage with the coupling groove by performing an rotation as the ratchets make contact with the sliding member.

According to another embodiment of the present invention, the ratchet locking section has a recess section such that a part of the ratchets is locked with the ratchet locking section.

According to another embodiment of the present invention, the slit extends up to the recess section of the ratchet locking section.

According to another embodiment of the present invention, the coupling groove comprises a first part having a shallow depth and a second part having a deep depth, and the first and second parts have bulk sections protruding toward an internal side of the coupling groove, respectively.

According to another embodiment of the present invention, the ratchet comprises a third part having a thin thickness and a fourth part having a thick thickness such that the ratchet has a shape corresponding to the coupling groove, the fourth part of the ratchet has a stepped portion locked with the second part of the coupling groove, and a slit is formed in an upper portion of a first side or a second side of the ratchet.

According to another embodiment of the present invention, an annular spring is inserted into the slit of the ratchet to provide elastic restoring force.

According to another embodiment of the present invention, the third part of the ratchet is coupled with the first part of the coupling groove, and the fourth part of the ratchet is coupled with the second part of the coupling groove.

### Advantageous Effects

According to the gear-driven assembly of transmission gear shifting of the present invention, a sliding member directly rotates a driven bevel gear or by indirectly rotating the driven bevel gear through a ratchet or an apparatus equivalent to the ratchet without stopping rotation of the driven bevel gear, so that gear-shifting can be easily performed during rotation of a driving bevel gear.

In more detail, the ratchet is installed at a ratchet installation section of a driven shaft such that the ratchet has elastic restoring force. In such a state, if the gear-driven assembly is not manipulated, the driven bevel gear performs an idle rotation because the driven bevel gear does not engage with the driven shaft. However, if the sliding member moves such that the ratchet protrudes outward of an outer peripheral surface of the driven shaft, the ratchet is locked with an inner peripheral surface of the driven bevel gear, so that the driven bevel gear rotates together with the driven shaft. Thus, gear-shifting can be easily performed because force required for movement of the sliding member is small as compared with the conventional transmission gear shifting.

### BRIEF DESCRIPTION OF THE DRAWINGS

The above and other advantages of the present invention will become readily apparent with reference to the following detailed description when considered in conjunction with the accompanying drawings wherein:

FIG. 1 is an exploded perspective view illustrating a conventional gear-driven assembly;

FIG. 2 is a perspective view illustrating the use of a bicycle provided with a gear-driven assembly of transmission gear shifting according to a first embodiment of the present invention;

FIG. 3 is a schematic view illustrating a state in which a gear-driven assembly of transmission gear shifting engages with a gear-driving assembly according to a first embodiment of the present invention;

FIG. 4 is an exploded perspective view illustrating a gear-driven assembly of transmission gear shifting according to a first embodiment of the present invention;

FIG. 5 is an assembled perspective view illustrating the gear-driven assembly of transmission gear of FIG. 4;

FIG. 6 is an enlarged perspective view illustrating the ratchet of FIG. 4;

FIG. 7 is a detailed perspective view illustrating the sliding member of FIG. 4;

FIG. 8 is a perspective view illustrating in a state in which the sliding member of FIG. 4 is coupled with a driving member;

FIG. 9 is an enlarged perspective view illustrating the driven shaft of FIG. 4;

FIG. 10 is a perspective view illustrating in a state in which a ratchet and an annular spring are installed at the driven shaft of FIG. 4;

FIG. 11 is a perspective view illustrating an operation state of a sliding member and a ratchet according to a first embodiment of the present invention;

FIG. 12 is a sectional view illustrating a gear-driven assembly before a protrusion of a sliding member pushes up a ratchet according to a first embodiment of the present invention;

FIG. 13 is a sectional view illustrating a gear-driven assembly before a protrusion of a sliding member pushes up a ratchet according to a first embodiment of the present invention;

FIG. 14 is a perspective view illustrating a state in which a plurality of driven bevel gears are installed at a driven shaft in a gear-driven assembly according to a second embodiment of the present invention;

FIG. 15 is an exploded perspective view illustrating the gear-driven assembly of FIG. 14;

FIG. 16 is a perspective view illustrating the gear-driven assembly of FIG. 14 at a different angle;

FIG. 17 is an enlarged view illustrating a state in which a ratchet is installed at a coupling groove of a driven bevel gear of FIG. 16;

FIG. 18 is a schematic view illustrating a state in which a ratchet protrudes according to movement of a sliding member in a gear-driven assembly according to a second embodiment of the present invention;

FIG. 19 is a schematic view illustrating a rotation direction of a driven bevel gear according to positions of a sliding member in a gear-driven assembly according to a second embodiment of the present invention; and

FIG. 20 is a schematic view illustrating a state in which a ratchet is installed at a driven bevel gear in order to describe the operation of a gear-driven assembly according to a second embodiment of the present invention.

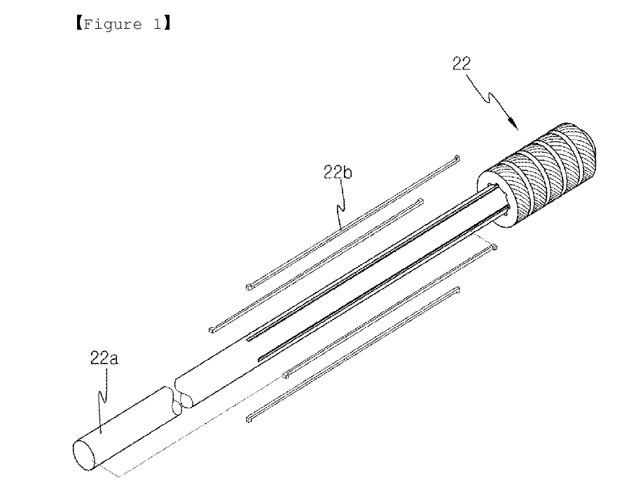

### MODE FOR THE INVENTION

Hereinafter, a gear-driven assembly of transmission gear shifting according to various embodiments of the present invention will be described in detail with reference to the accompanying drawings.

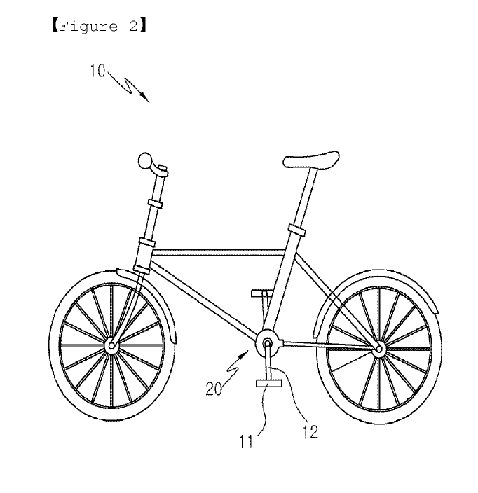

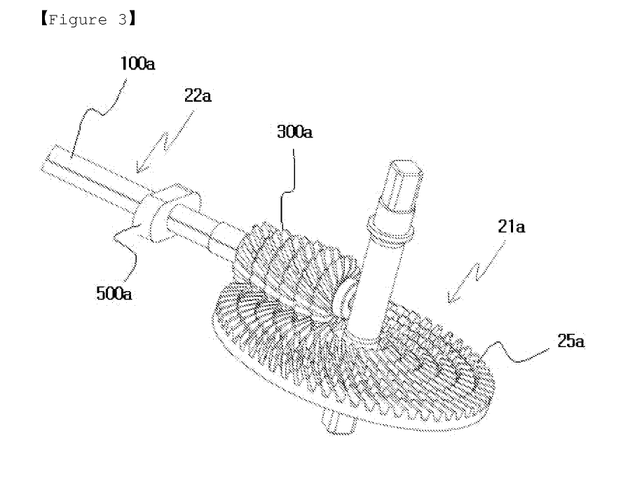

FIGS. 2 and 3 are views illustrating an example to which the gear-driven assembly of the present invention can be applied.

Referring to FIGS. 2 and 3, a pedal 10 of a bicycle 10 is connected with a crank 12, and the crank 12 is connected with a gear-driving assembly 21 in which a plurality of driving bevel gears 25 are concentrically arranged. Further, the gear-driving assembly 21 is connected with a gear-driven assembly 22, in which a plurality of driven bevel gears 300 are installed at a driven shaft 100, such that the driving bevel gears 25 engage with the driven bevel gears 300, respectively.

As disclosed in Korean Patent Registration No. 2008-0688611 entitled “transmission gear shifting for a bicycle,” one transmission gear shifting 20 comprises a bearing, a pinion assembly, a rack assembly, a movable plate and the like as well as the gear-driving assembly 21 and the gear-driven assembly 22.

As illustrated in FIG. 3, the driving bevel gears 25 of the gear-driving assembly 21 are concentrically arranged, and the driven bevel gears 300 of the gear-driven assembly 22 are installed at the driven shaft 100 such that the driven bevel gears 300 engage with the driving bevel gears 25, respectively.

FIGS. 2 and 3 illustrate one preferred example in which the gear-driven assembly of the present invention is installed. The technical scope of the present invention is not limited thereto.

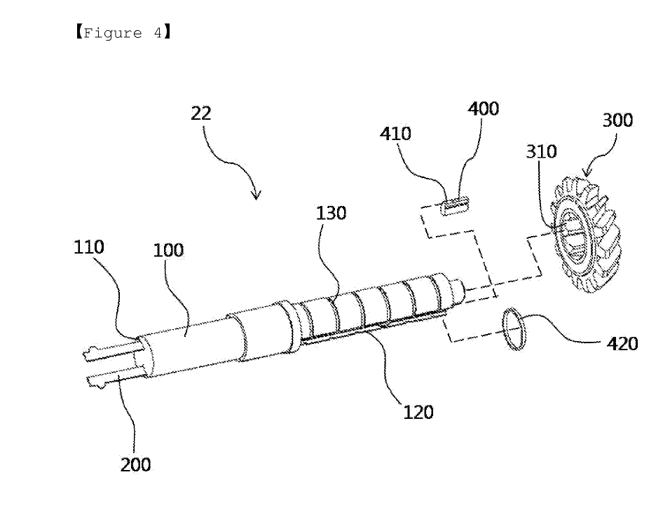

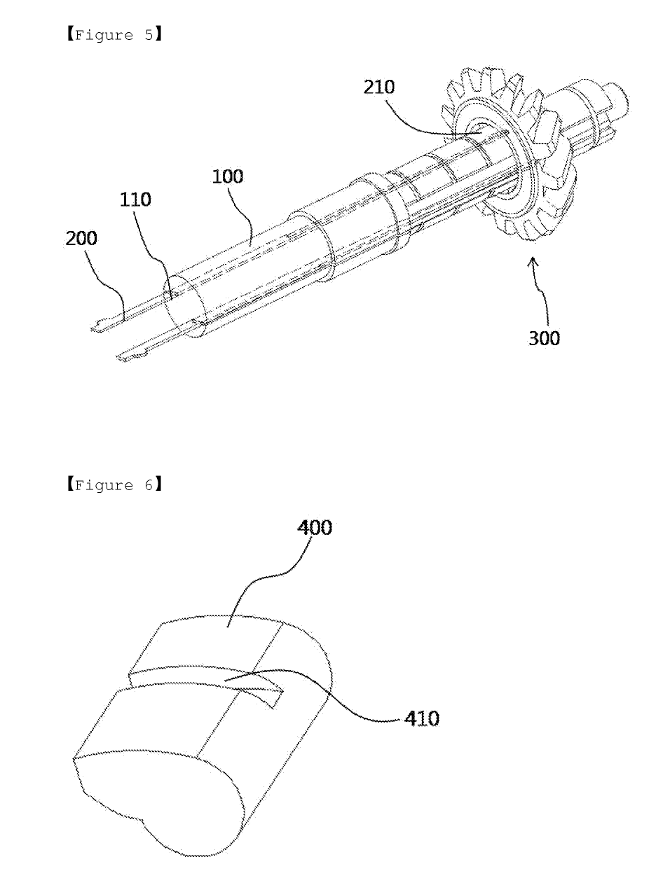

As illustrated in FIGS. 4 and 5, the gear-driven assembly 22 according to a first embodiment of the present invention comprises the driven shaft 100, the driven bevel gears 300 coupled with the driven shaft 100, sliding members 200 slidably inserted into the driven shaft 100 in the longitudinal direction of the driven shaft 100, and a plurality of ratchets 400 installed on the outer peripheral surface of the driven shaft 100.

In more detail, at least one slit 110 is formed in the outer peripheral surface of the driven shaft 100 in the longitudinal direction of the driven shaft 100, and at least one ratchet installation section 120 is formed along an extension line of the slit 110 formed in the driven shaft 100. The ratchet installation section 120 has a concave section such that the ratchets 400 can be installed therein. Preferably, when a plurality of slits 110 and a plurality of ratchet installation sections 120 are formed, the slits 110 are spaced apart from the ratchet installation sections 120 by a predetermined interval, respectively. The slit 110 extends to the ratchet installation section 120 lengthwise along the driven shaft 100.

The driven bevel gear 300 is formed with at least one coupling groove 310 in the inner peripheral surface thereof such that the ratchet 400 can be detachably inserted into the coupling groove 310. If a part of the ratchet 400 is inserted into the coupling groove 310, the driven shaft 100 rotates together with the driven bevel gear 300. If the ratchet 400 is separated from the coupling groove 310, the driven shaft 100 performs an idle rotation because the driven shaft 100 does not engage with the driven bevel gear 300.

Further, a plurality of annular slits 130 are formed in the outer peripheral surface of the driven shaft 100, in which the ratchet installation section 120 is formed, in the circumferential direction of the driven shaft 100. Annular springs 420 are installed in the annular slits 130, respectively, such that the ratchets 400 can be elastically installed in the ratchet installation section 120.

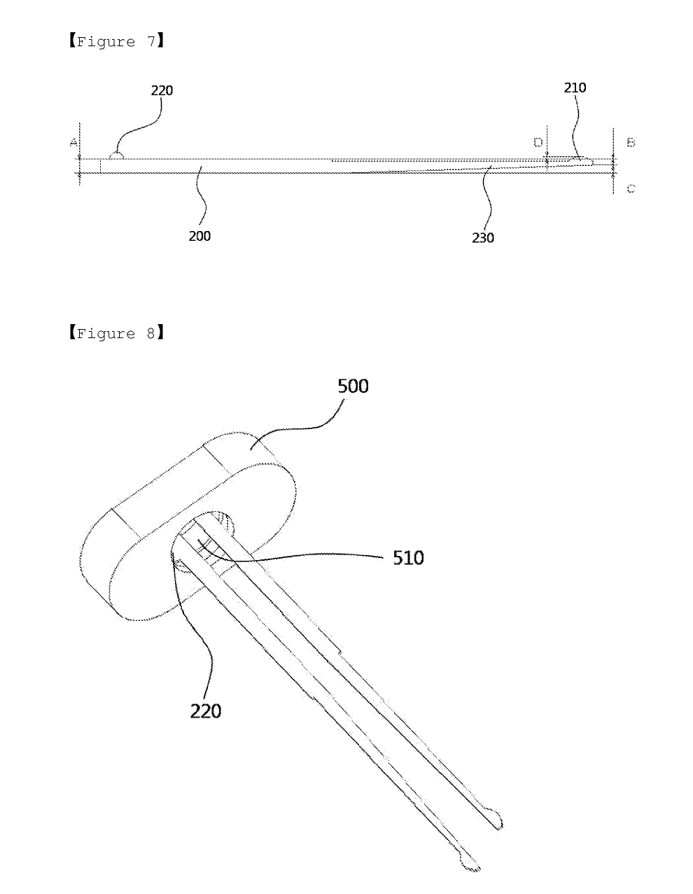

The ratchets 400 are installed in the ratchet installation section 120 in the longitudinal direction of the driven shaft 100. As illustrated in FIG. 6, one side of the ratchet 400 has an arc shape and the other side thereof has a narrow configuration, so that the ratchet 400 is prepared in the form of a rest. The ratchet 400 has a slit 410 at the upper surface thereof such that the annular spring 420 can be inserted into the slit 410. In detail, in a state in which the ratchet 400 is installed in the ratchet installation section 120, the annular slit 130 and the slit 410 of the ratchet 400 are positioned at the same circumferential line, and the annular spring 420 is inserted into the annular slit 130 and the slit 410.

The annular spring 420 is inserted into the annular slit 130 and the slit 410, so that the ratchet 400 has an elastic restoring force toward the driven shaft 100.

Such a method for installing the annular spring 420 is the most efficient and simplest method.

However, technology for allowing the ratchet 400 to have the elastic restoring force is not limited to the embodiment as described above. This can be achieved using various elastic members, various springs and the like.

A protrusion 210 of the sliding member 200 is inserted into the inner side of the ratchet 400 having the elastic restoring force while rotating in one direction, so that the ratchet 400 has a protruding shape.

As illustrated in FIG. 7, the sliding member 200 has a tapered section 230 at one end thereof. Preferably, the height A of one end of the sliding member 200 is equal to the sum of the height B of the other end of the sliding member 200 and the height C of the tapered section 230. Further, the tapered section 230 has the height C the same as the height D of the protrusion 210, so that the protruding height of the ratchet 400 caused by the protrusion 210 can keep balance with the height C of the tapered section 230 by means of elasticity of the sliding member 200.

As the sliding member 200 slides into the ratchet installation section 120 along the slit 110 of the driven shaft 100, the protrusion 210 of the sliding member 200 pushes a concave section of the bottom portion of the ratchet 400, so that the concave section of the ratchet 400 is locked with the coupling groove 310 of the driven bevel gear 300. In such a state, if the sliding member 200 slides leftward and rightward, the protrusion 210 that pushes the concave section of the ratchet 400 may deviate from the push position, so that the ratchet 400 returns to the original state by restoring force of the annular spring 420, and the driven shaft 100 performs an idle rotation relative to the driven bevel gear 300.

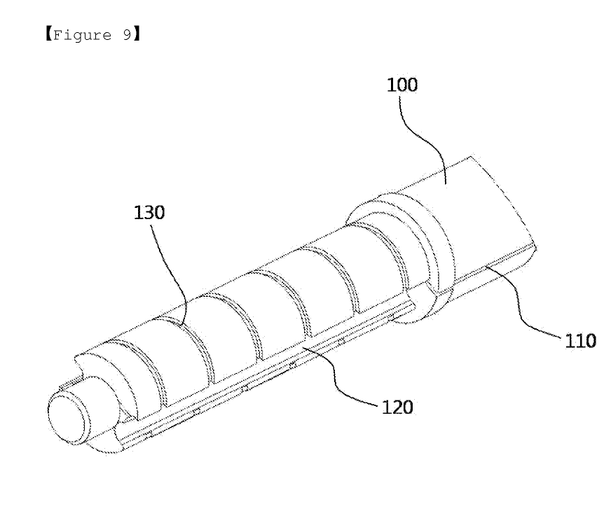

As illustrated in FIG. 8, the sliding member 200 moves by a driving member 500. The driving member 500 moves through a wire or an external transfer apparatus manipulated by a user.

The driving member 500 has a locking groove 510 at the inner side thereof, and the sliding member 200 has a locking protrusion 220 at one side thereof such that the locking protrusion 220 can be locked with the locking groove 510. Thus, as the driving member 500 moves, the sliding member 200 slides along the driven shaft 100.

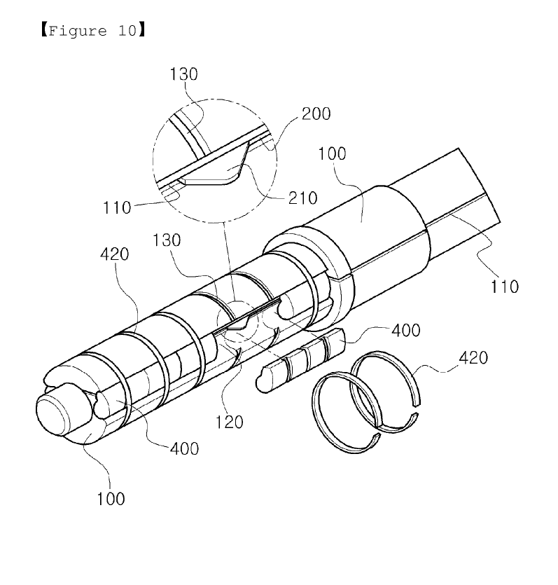

FIG. 9 is a perspective view illustrating the driven shaft 100 before the ratchet 400 is not installed at the ratchet installation section 120, and FIG. 10 is a perspective view illustrating the driven shaft 100 after the ratchet 400 is installed at the ratchet installation section 120. The ratchet 400 is installed at the ratchet installation section 120 by the annular spring 420 and the sliding member 200 is slidably inserted into the slit 110. As illustrated in FIG. 10, when the ratchet 400 does not make contact with the sliding member 200, the ratchet 400 is seated at the ratchet installation section 120 by the annular spring 420 while being arranged concentrically with the outer peripheral surface of the driven shaft 100.

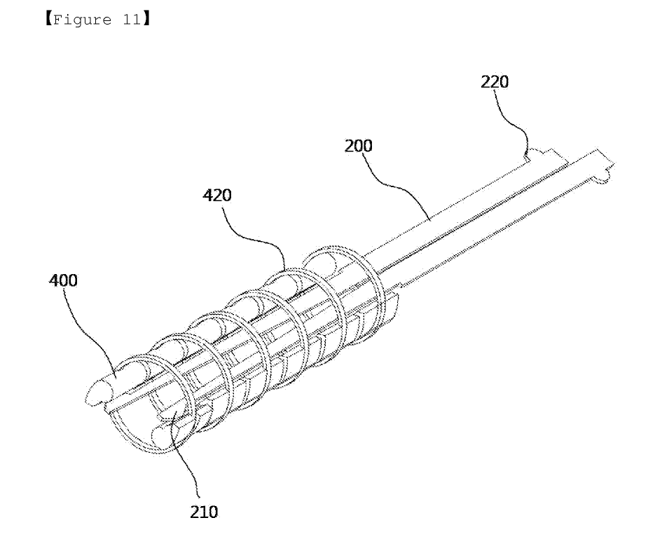

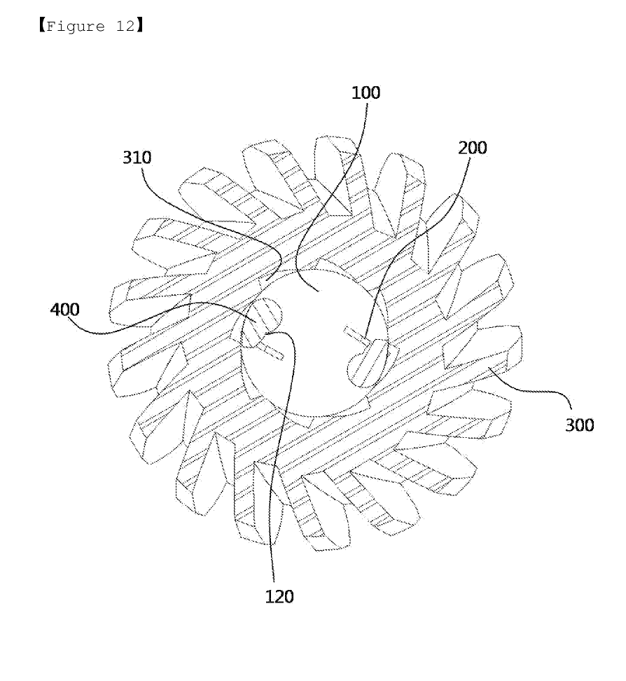

FIG. 11 is a view illustrating the operation state of the sliding member 200 and the ratchet 400 according to the first embodiment of the present invention. FIG. 11 shows a structure in which the sliding member 200 slides to the lower portion of the certain ratchet 400, so that the protrusion 210 of the sliding member 200 pushes the concave section of the ratchet 400.

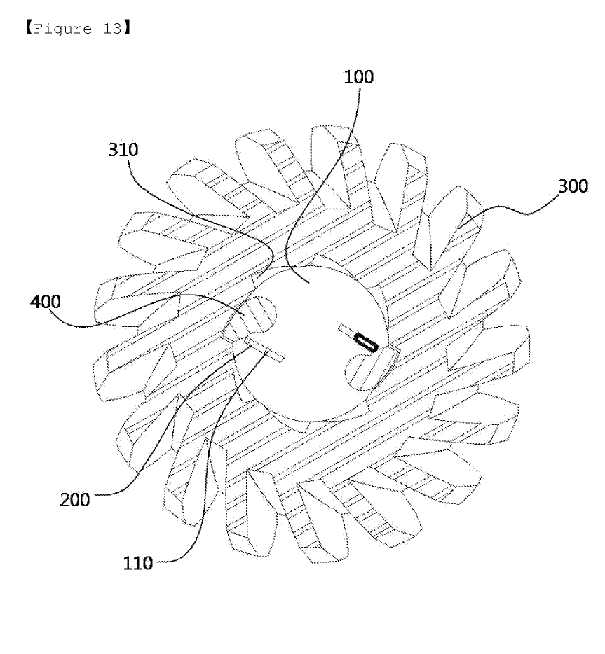

FIG. 12 is a sectional view illustrating the gear-driven assembly before the protrusion of the sliding member pushes up the ratchet according to the first embodiment of the present invention, and FIG. 13 is a sectional view illustrating the gear-driven assembly after the protrusion of the sliding member pushes up the ratchet according to the second embodiment of the present invention.

As illustrated in FIG. 12, if the protrusion 210 of the sliding member 200 does not reach the ratchet 400 and does not make contact with the ratchet 400, the ratchet 400 does not move at the original position. Thus, the driven shaft 100 performs an idle rotation relative to the driven bevel gear 300.

However, as illustrated in FIG. 13, if the protrusion 210 of the sliding member 200 pushes the concave section of the ratchet 400, the concave section of the ratchet 400 is locked with the coupling groove 310 of the driven bevel gear 300 and the arc-shaped portion of the ratchet 400 is inserted into the ratchet installation section 120 of the driven shaft 100. Thus, the driven shaft 100 rotates together with the driven bevel gear 300 while engaging with the driven bevel gear 300.

Hereinafter, the operation of the gear-driven assembly 22 according to the first embodiment of the present invention will be described again.

If a user drives the driving member 500 through a wire or an external transfer apparatus (not shown), the sliding member 200 slides in the driven shaft 100. At this time, if the protrusion 210 of the sliding member 200 stops at a transmission position desired by the user, the protrusion 210 naturally pushes up the concave section of the ratchet 400, so that the concave section of the ratchet 400 is locked with the coupling groove 310 of the driven bevel gear 300. Thus, the driven shaft 100 rotates together with the driven bevel gear 300.

However, if the sliding member 200 slides at a different position through manipulation of the driving member 500, the protrusion 210 is separated from the ratchet 400. Thus, the ratchet 400 returns to the ratchet installation section 120 by restoring force of the annular spring 420, and the driven shaft 100 performs an idle rotation relative to the driven bevel gear 300.

Hereinafter, the gear-driven assembly of the transmission gear shifting according to the second embodiment of the present invention will be described in detail with reference to the accompanying drawings.

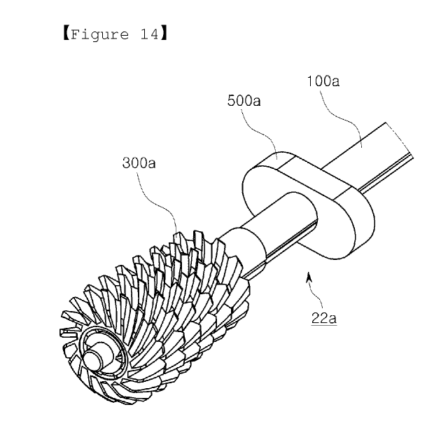

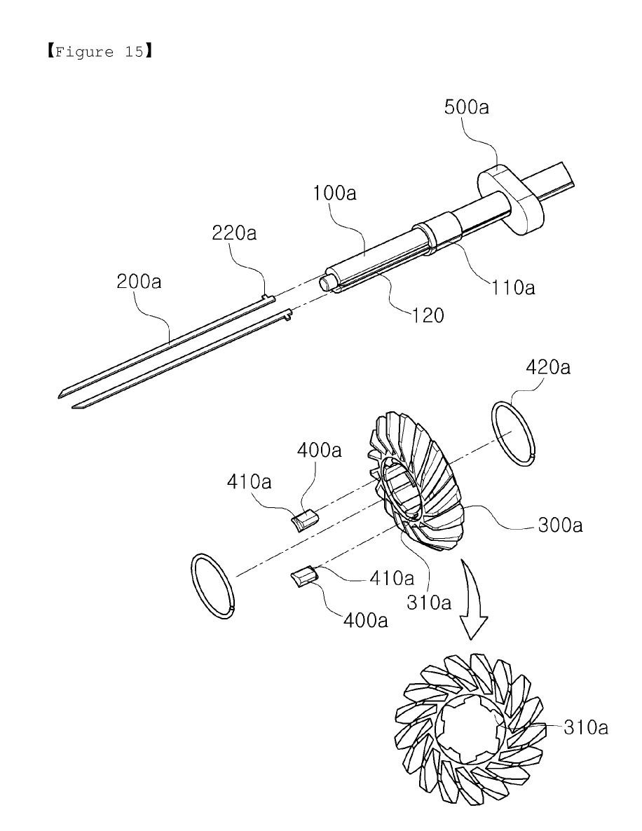

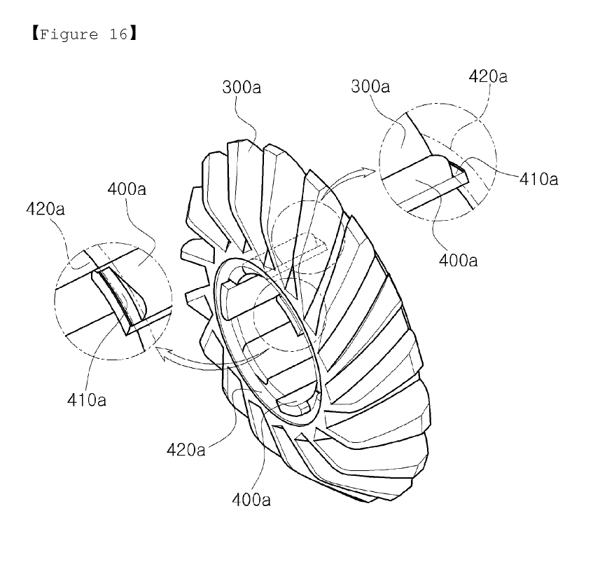

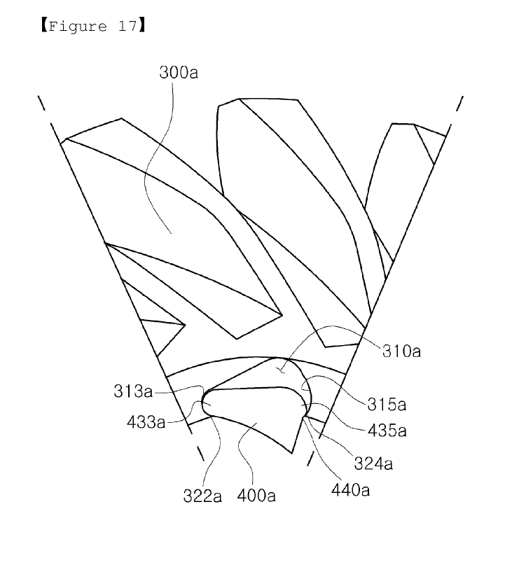

FIG. 14 is a perspective view illustrating a state in which a plurality of driven bevel gears are installed at a driven shaft in the gear-driven assembly according to the second embodiment of the present invention, and FIG. 15 is an exploded perspective view illustrating the gear-driven assembly. FIG. 16 is a view illustrating a state in which a plurality of ratchets are installed at the driven bevel gear, and FIG. 17 is an enlarged view illustrating a state in which the ratchets are installed at coupling grooves of the driven bevel gear of FIG. 16.

As illustrated in FIGS. 14 and 15, the gear-driven assembly 22a according to another embodiment of the present invention comprises a driven shaft 100a, a plurality of driven bevel gears 300a, a sliding member 200a and a plurality of ratchets 400a. The driven bevel gears 300a are coupled with the driven shaft 100a. The sliding member 200a is slidably inserted into the driven shaft 100a in the longitudinal direction of the driven shaft 100a. The ratchets 400a are installed on the outer peripheral surface of the driven shaft 100a and the inner peripheral surfaces of the driven bevel gears 300a.

In more detail, at least one slit 110a is formed in the outer peripheral surface of the driven shaft 100a in the longitudinal direction of the driven shaft 100a, and at least one ratchet locking section 120a is formed along an extension line of the slit 110a formed in the driven shaft 100a. The ratchet locking section 120a has a recess section such that a part of the ratchets 400a can be locked with the ratchet locking section 120a. Preferably, when a plurality of slits 110a and a plurality of ratchet locking sections 120a are formed, the slits 110a are spaced apart from the ratchet locking sections 120a by a predetermined interval, respectively. The slit 110a extends up to the recess section of the ratchet locking section 120a.

The driven bevel gear 300a is formed with at least one coupling groove 310a in the inner peripheral surface thereof. One side of the ratchet 400a is installed at the coupling groove 310a and the other side of the ratchet 400a is locked with the ratchet locking section 120a.

As illustrated in FIGS. 16 and 17, the coupling groove 310a comprises a part 313a having a shallow depth and a part 315a having a deep depth. The parts 313a and 315a have bulk sections 322a and 324a protruding toward the internal side of the coupling groove 310a, respectively.

The ratchet 400a has a shape corresponding to the coupling groove 310a, and comprises a part 433a having a thin thickness and a part 435a having a thick thickness. A slit 410a is formed in the upper portion of one side of the ratchet 400a such that an annular spring 420 can be installed in the slit 410a.

The part 433a of the ratchet 400a is coupled with the part 313a of the coupling groove 310a, and the part 435a of the ratchet 400a is coupled with the part 315a of the coupling groove 310a. Preferably, the part 435a of the ratchet 400a has a stepped portion 440a locked with the part 315a of the coupling groove 310a.

In a state in which the ratchet 400a is coupled with the coupling groove 310a, the part 433a is inserted into the coupling groove 310a, an upper portion of the part 435a is inserted into the coupling groove 310a, and a lower portion of the part 435a protrudes toward the center portion of the driven bevel gear 300a. In such a state, if the driven shaft 100a is coupled with the driven bevel gear 300a, the part 435a of the ratchet 400a is locked with the ratchet locking section 120a of the driven shaft 100a.

The driven bevel gear 300a has a plurality of coupling grooves 310a in the inner peripheral surface thereof, and one ratchet 400a is installed at each coupling groove 310a. According to the embodiment, six ratchets 400a are installed at six coupling grooves 310a. However, the present invention is not limited thereto.

At this time, the slots 410a may be formed in the upper portion of one side of the ratchets 400a or in the upper portion of the other side of the ratchets 400a in correspondence with each other.

Thus, when installing the ratchets 400a in the coupling groove 310a, the ratchets 400a having different shapes can be alternatively installed according to an installation direction the coupling groove 310a. Further, the annular spring 420a is inserted into the slit 410a, so that a part of the part 435a of the ratchet 400a can be separated from the coupling groove 310a by elastic restoring force of the annular spring 420a.

The sliding member 200a is inserted into the slit 110a to push the part 435a of the ratchet 400a. The sliding member 200a has a predetermined width, and moves by a driving member 500a. The driving member 500a moves through a wire or an external transfer apparatus manipulated by a user. Since the operation of the driving member 500a is generally known in the art, a detailed description will be omitted.

In a state in which the sliding member 200a is not inserted into the slit 110a of the ratchet locking section 120a, since the ratchet locking section 120a of the driven shaft 100a is connected with the coupling groove 310a of the driven bevel gear 300a through the ratchet 400a, the driven shaft 100a rotates together with the driven bevel gear 300a.

However, if the sliding member 200a pushes the part 435a of the ratchet 400a while making contact with the part 435a through sliding, the ratchet 400a is completely inserted into the coupling groove 310a and the driven shaft 100a performs an idle rotation relative to the driven bevel gear 300a.

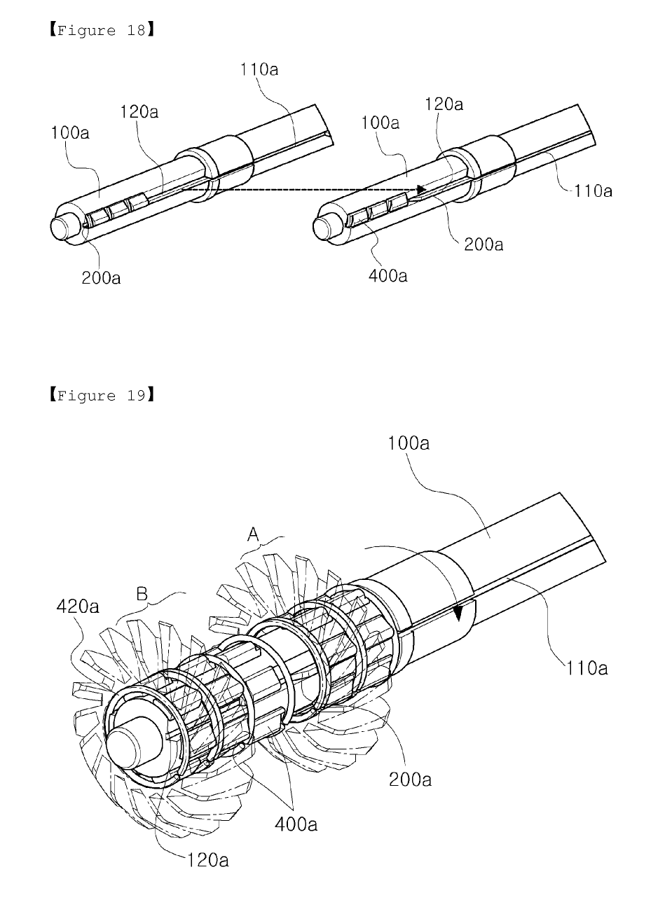

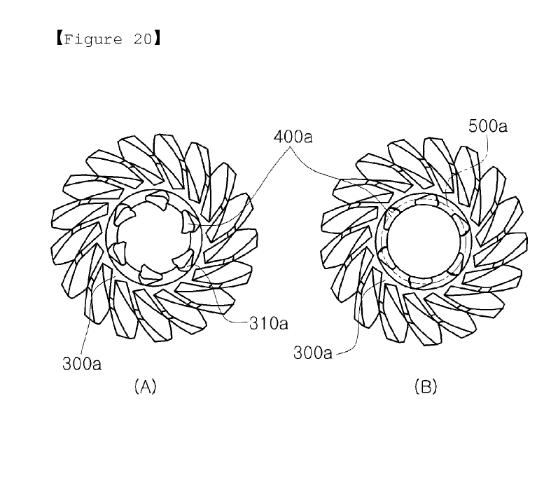

FIG. 18 is a schematic view illustrating a state in which the ratchet protrudes according to movement of the sliding member in the gear-driven assembly according to the second embodiment of the present invention, and FIG. 19 is a schematic view illustrating a rotation direction of the driven bevel gear according to positions of the sliding member in the gear-driven assembly according to the second embodiment of the present invention.

As illustrated in FIGS. 18 and 19, as the sliding member 200a slides toward the ratchet locking section 120a along the slit 110a of the driven shaft 100a, the sliding member 200a pushes the part 435a of the ratchet 400a toward the coupling groove 310a, so that the ratchet 400a is completely inserted into the coupling groove 310a of the driven bevel gear 300a. In such a state, the driven shaft 100a performs an idle rotation relative to the driven bevel gear 300a (see A of FIG. 19).

Then, if the sliding member 200a that pushes the part 435a of the ratchet 400a deviates from the push position, the ratchet 400a returns to the original state by restoring force of the annular spring 420a. In detail, a part of the part 435a of the ratchet 400a is separated from the coupling groove 310a and is locked with the ratchet locking section 120a of the driven shaft 100a, so that the driven shaft 100a rotates together with the driven bevel gear 300a (see B of FIG. 19).

FIG. 20 is a schematic view illustrating a state in which the ratchet is installed at the driven bevel gear in order to describe the operation of the gear-driven assembly according to the second embodiment of the present invention, FIG. 20A is a schematic view illustrating a state in which the ratchet is locked with the coupling groove of the driven bevel gear and the ratchet locking section of the driven shaft, and FIG. 20B is a schematic view illustrating a state in which the ratchet is completely inserted into the coupling groove of the driven bevel gear.

If the sliding member 200a is inserted into the slit 110a and then reaches the lower portion of the driven bevel gear 300a, the sliding member 200a pushes up the part 435a of the ratchet 400a, so that the ratchet 400a is completely inserted into the coupling groove 310a of the driven bevel gear 300a. Thus, the inner peripheral surface of the driven bevel gear 300a has a circular shape, so that the driven bevel gear 300a performs an idle rotation about the driven shaft 100a.

In contrast, in a state in which the sliding member 200a does not reach the lower portion of the driven bevel gear 300a, a part of the part 435a of the ratchet 400a is locked with the ratchet locking section 120a of the driven shaft 100a by elastic restoring force of the annular spring 420a. At this time, the ratchet 400a is locked with the coupling groove 310a and the ratchet locking section 120a, so that the driven shaft 100a rotates together with the driven bevel gear 300a.

According to the gear-driven assembly using the ratchet 400a as described above, the sliding member 200a reaches the lower portion of the driven bevel gear 300a and pushes the ratchet 400a to the coupling groove 310a, so that the driven bevel gear 300a performs an idle rotation. In such a state, if the sliding member 200a returns to the original position (the right direction in FIG. 20) from the lower portion of the driven bevel gear 300a, the driven bevel gear 300a together with the driven shaft 100a.

1. A gear-driven assembly of transmission gear shifting having a gear-driving assembly in which a plurality of driving bevel gears are concentrically arranged, the gear-driven assembly comprising:
a plurality of driven bevel gears engaging with the driving bevel gears of the gear-driving assembly, respectively;
a driven shaft formed with at least one slit in an outer peripheral surface thereof in a longitudinal direction thereof, and having at least one ratchet installation section along an extension line of the slit;
a sliding member inserted into the slit to slide to the ratchet installation section in a longitudinal direction of the ratchet installation section; and
a plurality of ratchets installed between the ratchet installation section of the driven shaft and a coupling groove of the driven bevel gear such that the ratchets have elastic restoring force, in which the ratchets entirely or partially engage with the coupling groove by performing rotation as the ratchets make contact with the sliding member,
wherein each driven bevel gear is coupled with the driven shaft and is formed with the coupling groove in an inner peripheral surface thereof.

2. The gear-driven assembly of transmission gear shifting as claimed in claim 1, wherein a protrusion is formed at an end of the sliding member, and a lower portion of the sliding member is tapered toward the protrusion.

3. The gear-driven assembly of transmission gear shifting as claimed in claim 2, if the protrusion of the sliding member is inserted into a lower portion of the ratchet, a first side of the ratchet is locked with the coupling groove of the driven bevel gear and a second side of the ratchet is positioned at the ratchet installation section of the driven shaft, so that the driven bevel gear and the driven shaft, at which the protrusion of the sliding member is located, are driven.

4. The gear-driven assembly of transmission gear shifting as claimed in claim 1, wherein a slit is formed across a center portion of an upper surface of the ratchet.

5. The gear-driven assembly of transmission gear shifting as claimed in claim 4, wherein a plurality of annular slits are formed in an outer peripheral surface of the driven shaft at which the ratchet installation section is formed, and an annular spring is inserted into the annular slit and the slit of the ratchet after the annular slit and the slit of the ratchet are positioned at a same circumferential line.

6. A gear-driven assembly of transmission gear shifting provided with a gear-driving assembly in which a plurality of driving bevel gears are concentrically arranged, the gear-driven assembly comprising:
a plurality of driven bevel gears engaging with the driving bevel gears of the gear-driving assembly, respectively;
a driven shaft formed with at least one slit in an outer peripheral surface thereof in a longitudinal direction thereof, and provided with at least one ratchet locking section along an extension line of the slit;
a sliding member inserted into the slit to slide to the ratchet locking section in a longitudinal direction of the ratchet locking section; and
a plurality of ratchets inserted into a coupling groove of the driven bevel gear such that the ratchets have elastic restoring force, in which the ratchets entirely or partially engage with the coupling groove by performing an rotation as the ratchets make contact with the sliding member,
wherein each driven bevel gear is coupled with the driven shaft and is formed with the coupling groove in an inner peripheral surface thereof.

7. The gear-driven assembly of transmission gear shifting as claimed in claim 6, wherein the ratchet locking section has a recess section such that a part of the ratchets is locked with the ratchet locking section.

8. The gear-driven assembly of transmission gear shifting as claimed in claim 7, wherein the slit extends up to the recess section of the ratchet locking section.

9. The gear-driven assembly of transmission gear shifting as claimed in claim 6, wherein the coupling groove comprises a first part having a shallow depth and a second part having a deep depth, and the first and second parts have bulk sections protruding toward an internal side of the coupling groove, respectively.

10. The gear-driven assembly of transmission gear shifting as claimed in claim 9, wherein the ratchet comprises a third part having a thin thickness and a fourth part having a thick thickness such that the ratchet has a shape corresponding to the coupling groove, the fourth part of the ratchet has a stepped portion locked with the second part of the coupling groove, and a slit is formed in an upper portion of a first side or a second side of the ratchet.

11. The gear-driven assembly of transmission gear shifting as claimed in claim 10, wherein an annular spring is inserted into the slit of the ratchet to provide elastic restoring force.

12. The gear-driven assembly of transmission gear shifting as claimed in claim 6, wherein the sliding member has a length with a predetermined width.

13. The gear-driven assembly of transmission gear shifting as claimed in claim 10, wherein the third part of the ratchet is coupled with the first part of the coupling groove, and the fourth part of the ratchet is coupled with the second part of the coupling groove.
